(19) United States
(12) Patent Application Publication
(10) Pub. No.: US 2003/0040824 A1
(43) Pub. Date: Feb. 27, 2003

(54) Methods and apparatus for facilitating manufacturing

(76) Inventors: Michael H. Feige, Bridgenorth (CA); Allan J. Robinson, Peterborough (CA); Christian R. Feige, Peterborough (CA)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/682,327

(22) Filed: Aug. 21, 2001

(51) Int. Cl. G06F 19/00

(52) U.S. Cl. 700/105; 700/96

(57) ABSTRACT

A method for facilitating manufacturing includes capturing changes to a part from a process, incorporating the captured changes in a regenerated electronic model, and utilizing the regenerated model to further fabricate the part.

### BACKGROUND OF INVENTION

This invention relates generally to electronic modeling and designing, and, more particularly, to regenerating models.

In manufacturing, an initial design stage includes designing a part, then choosing materials for the part and determining a process to make the part. Typically, as part of the design phase, the manufacturer will model the part utilizing electronic modeling tools, such as, for example, Pro/ENGINEER commercially available from Parametric Technology Corporation, Waltham, Mass. Oftentimes, the manufacturer will rely on an outside supplier to provide the material or a partially fabricated part and the manufacturer finishes fabrication internally. Typically, the supplier is provided dimensions including tolerances for the partially fabricated part. The manufacturer receives the partially fabricated part and performs final fabrication processes. For example, a motor manufacturer will specify dimensions for a rotor shaft and a supplier will produce a forging and rough machine the forging to provide a rough part with dimensions within the specified tolerances. The motor manufacturer receives the rough machined part and performs a final machining to complete fabrication of the rotor shaft.

However, during the rough machining and/or the forging process, the supplier will typically sample the metallurgical properties of the rotor shaft by removing samples of metal for testing purposes, typically, leaving voids or holes in the rotor shaft. Additionally, the dimensions of the rotor will vary due to the specified tolerances. Accordingly, the model originally generated during the design stage is not always sufficient for use during a finish machining operation.

### SUMMARY OF INVENTION

In one aspect, a method for facilitating manufacturing includes capturing changes to a part from a process, incorporating the captured changes in a regenerated electronic model, and utilizing the regenerated model to further fabricate the part.

In another aspect, apparatus for facilitating manufacturing includes at least one device and a server connected to the device and configured to download to the device information regarding a part. The server is further configured to upload from the device at least one of a regenerated model and at least one captured change entered into a user interface, and regenerate a model upon receipt of the captured change.

In a further aspect, a method for facilitating manufacturing includes generating an electronic model of a part, sending the electronic model to a supplier, utilizing the supplier to capture changes to the part from a fabrication process, incorporating the captured changes in a regenerated electronic model utilizing the captured changes and the electronic model, and utilizing the regenerated model to further fabricate the part.

### BRIEF DESCRIPTION OF DRAWINGS

FIG. 1 is block diagram of a system in accordance with one embodiment of the invention.

FIG. 2 is process map for one embodiment of a method for regenerating electronic models.

### DETAILED DESCRIPTION

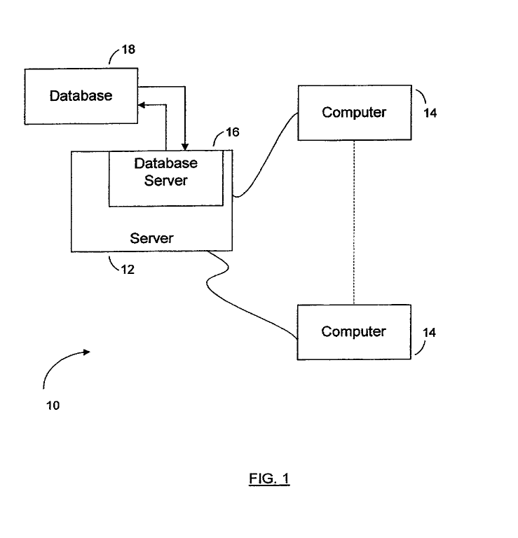

FIG. 1 is a block diagram of a system 10 in accordance with one embodiment of the invention. System 10 includes a server sub-system 12, sometimes referred to herein as server 12, and a plurality of user devices 14 connected to server 12. In one embodiment, devices 14 are computers including a web browser, and server 12 is accessible to devices 14 via a network such as an intranet or the Internet. In an alternative embodiment, devices 14 are servers for a network of supplier devices.

Devices 14 are interconnected to the network, such as a local area network (LAN) or a wide area network (WAN), through many interfaces including cable modems, high-speed ISDN lines (Integrated Services Digital Network), and dial in connections including phone modems and DSL connections (Digital Subscriber Line). Alternatively, devices 14 are any device capable of interconnecting to a network including a network-based telephone or other network-based connectable equipment including a hand-held wireless device. Server 12 includes a database server 16 connected to a centralized database 18 containing information about a part. In one embodiment, centralized database 18 is stored on database server 16 and can be accessed by potential users at one of user devices 14 by logging onto server sub-system 12 through one of user devices 14. In an alternative embodiment centralized database 18 is stored remotely from server 12.

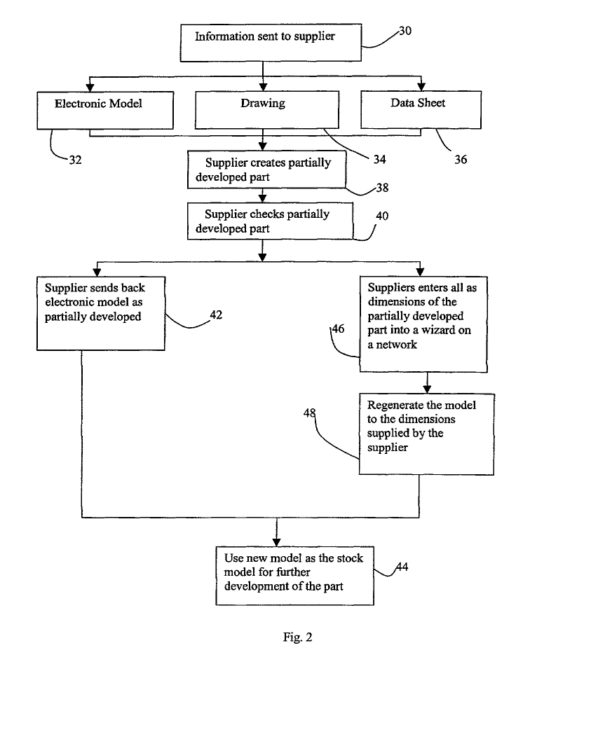

FIG. 2 is a process map for one embodiment of a method for regenerating electronic models. The method includes sending 30 information regarding a part to a supplier. In an exemplary embodiment, the information includes an electronic model 32 of the part or a drawing 34 of the part and a data sheet 36 regarding material properties of the part and dimensions including tolerances. The manufacturer stores the information in database 18 (shown in FIG. 1) and server 12 downloads the information to the supplier's computer 14. The supplier utilizes the information to create 38 a partially developed part and then inspects 40 the partially developed part. In one embodiment, the supplier inspects 40 the partially developed part by taking a plurality of dimensional measurements. By inspecting 40 the partially developed part, the supplier captures changes in the part resulting from the manufacturing process. The captured changes are the differences between electronic model 32 and the partially developed part.

In another embodiment, the supplier inspects 40 the forging by taking material samples and analyzing properties of the material such as density, elastic modulus, electrical resistivity, heat capacity, heat of combustion, heat of fusion, heat of vaporization, heat transfer coefficient, kinematic viscosity, Poisson“s ratio, thermal conductivity, thermal expansion coefficient, compressive strength, fracture toughness, friction coefficients, hardness, internal stress, piezoelectric coefficient and constant, porosity, residual stress/Young's Modulus, root-mean-square (rms) roughness, shear modulus, specific heat, stiffness, strain, tensile strength, ultimate strength, and yield strength.

If the supplier has access to the specific computer program that generated electronic model 32, the supplier regenerates electronic model 32 incorporating the information obtained through inspecting 40 the partially developed part and sends 42 the regenerated model to the manufacturer. The manufacturer utilizes 44 the regenerated model to further fabricate the part. In an exemplary embodiment, the supplier utilizes computer 14 and server 12 (shown in FIG. 1) to send 42 the regenerated model to the manufacturer, and the manufacturer utilizes 44 the regenerated model to fabricate a finished part.

If the supplier does not have access to the particular program that generated electronic model 32, the supplier enters 46 the information obtained from inspecting 40 the part into computer 14 and system 10 (shown in FIG. 1) uploads the information to server 12 and the manufacturer regenerates 48 an electronic model 32 incorporating the entered information. The regenerated model is utilized 44 to further fabricate the part. In an exemplary embodiment, the supplier enters the information into a user interface running on at least one of server 12 and computer 14. In an alternative embodiment, the supplier performs a manufacturing process on the part and then inspects 40 the further developed part. The information is obtained by inspecting the further developed part and capturing any changes to the part by the manufacturing process. The captured changes are incorporated in a regenerated model which is utilized 44 in further fabrication operations.

In an alternative embodiment, a plurality of suppliers perform fabrication tasks on a part and each supplier inspects 40 the part and supplies the information obtained to the next receiver of the part. For example, a first supplier creates 38 a partially developed part using a partial development process and inspects 40 the partially developed part before sending 42 a first regenerated model incorporating the information obtained from inspecting 40 to a second supplier along with the partially developed part. The second supplier further develops the partially developed part using a further development process utilizing 44 the first regenerated model and after inspecting 40 the further developed part and capturing changes, sends 42 a second regenerated model to the manufacturer along with the further developed part. The manufacturer utilizes 44 the second regenerated model to further fabricate or finish the part.

In an alternative embodiment, the first user partially develops the part and enters 46 information obtained through inspecting 40 the partially developed part into a user interface running on at least one of server 12 and a first computer 14 accessible by the first supplier. System 10 regenerates an electronic model 32 incorporating the entered information and sends 30 the second supplier the first regenerated model. The second supplier receives the first regenerated model and the partially developed part and then further develops the partially developed part. The second supplier obtains information from inspecting 40 the further developed part and enters 46 the information into a user interface running on at least one of server 12 and a second computer 14 accessible by the second supplier. In one embodiment, the user interface is a wizard.

In a further alternative embodiment, a plurality of suppliers perform various processes on the part and some suppliers send 42 regenerated electronic models to the part“s next destination while other suppliers enter 46 information obtained from inspecting 40 the part into a user interface and system 10 regenerates an electronic model and downloads the regenerated model to the part's next destination. Accordingly, each process that changes the part is captured and a new model is regenerated before any other process is started. In one embodiment, the part is at least partially metallic and the processes include, but are not limited to, forging, rough machining, finish machining, and inspecting. In another embodiment, the part is fabricated completely of metal.

Additionally, since system 10 operates nearly instantaneously and moving the part from a supplier to another supplier or to the manufacturer typically takes at least one day, the receiver of the part (the manufacturer or second supplier) receives the regenerated model sufficiently before the part such that the receiver can perform interference inspecting and produce numerical controlled (NC) tapes prior to the parts arrival. Accordingly, once the part arrives, the receiver can load the NC tapes in a machining tool and machining can start upon receipt of the part. Therefore, system 10 and the method mapped in FIG. 2 facilitate a reduction in manufacturing time and, thus, manufacturing costs.

While the invention has been described in terms of various specific embodiments, those skilled in the art will recognize that the invention can be practiced with modification within the spirit and scope of the claims.

1] A method for facilitating manufacturing, said method comprising:
capturing changes to a part from a process;
incorporating the captured changes in a regenerated electronic model; and
utilizing the regenerated model to further fabricate the part.

2] A method in accordance with claim 1 wherein said capturing changes further comprises capturing changes to a part from a process by inspecting the part after the process.

3] A method in accordance with claim 1 wherein said capturing changes further comprises capturing changes to a part from a process by inspecting the part after the process for at least one of a dimension, a density, an elastic modulus, an electrical resistivity, a heat capacity, a heat of combustion, a heat of fusion, a heat of vaporization, a heat transfer coefficient, a kinematic viscosity, a Poisson's ratio, a thermal conductivity, a thermal expansion coefficient, a compressive strength, a fracture toughness, at least one friction coefficient, a hardness, an internal stress, a piezoelectric coefficient, a piezoelectric constant, a porosity, a residual stress, a root-mean-square (rms) roughness, a shear modulus, a specific heat, a stiffness, a strain, a tensile strength, an ultimate strength, and a yield strength.

4] A method in accordance with claim 1 wherein said capturing changes further comprises capturing changes to a part from a process by inspecting the part after at least one of a partial development process, a further development process, and an inspection process.

5] A method in accordance with claim 1 wherein said capturing changes further comprises capturing changes to a part from a process by inspecting the part after the process wherein the process includes at least one of a forging process, a rough machining process, and an inspecting process.

6] A method in accordance with claim 1 wherein said capturing changes further comprises capturing changes to a part from a process by inspecting the part after the process wherein the process includes at least one of a forging process, a rough machining process, and an inspecting process including removing a sample from the part creating at least one void in the part.

7] A method in accordance with claim 1 wherein said capturing changes further comprises:
sending information to a supplier; and
capturing changes to a part from processes done by the supplier.

8] A method in accordance with claim 7 wherein said sending information to a supplier further comprises sending at least one of an electronic model of the part, a drawing of the part, and a data sheet relating to the part to the supplier.

9] A method in accordance with claim 7 wherein said sending information to a supplier further comprises sending at least one of an electronic model of the part, a drawing of the part, and a data sheet relating to the part including dimensions and tolerances to the supplier.

10] A method in accordance with claim 1 wherein said capturing changes further comprises sending an electronic model to the supplier, said incorporating the captured changes further comprises incorporating the captured changes with the electronic model in a regenerated electronic model.

11] A method in accordance with claim 1 wherein said incorporating the captured changes further comprises receiving the captured changes via a network utilizing a user interface.

12] A method in accordance with claim 10 wherein said receiving the captured changes further comprises receiving the captured changes via a network including at least one of a WAN, a LAN, and the Internet.

13] A method for facilitating manufacturing, said method comprising:
generating an electronic model of a part;
sending the electronic model to a supplier;
utilizing the supplier to capture changes to the part from a fabrication process;
incorporating the captured changes in a regenerated electronic model utilizing the captured changes and the electronic model; and
utilizing the regenerated electronic model to further fabricate the part.

14] A method in accordance with claim 13 wherein said utilizing the supplier further comprises utilizing the supplier to capture changes to the part from a fabrication process comprising at least one of a partial development process, a further development process, and a inspection process.

15] A method in accordance with claim 13 wherein said utilizing the supplier further comprises utilizing the supplier to capture changes to the part from a fabrication process comprising at least one of a forging process, a rough machining process, and an inspection process.

16] A method in accordance with claim 13 wherein said utilizing the supplier further comprises utilizing the supplier to capture changes to the part from a fabrication process comprising at least one of a forging process, a rough machining process, and an inspection process involving removal of material from the part.

17] Apparatus for facilitating manufacturing, said apparatus comprising:
at least one device; and
a server connected to said device and configured to:
download to said device information regarding a part;
upload from said device at least one of a regenerated model and at least one captured change entered into a user interface; and
regenerate a model upon receipt of the captured change.

18] An apparatus in accordance with claim 17 wherein said server further configured to download to said device information regarding a part, wherein the information comprises at least one of an electronic model of the part, a drawing of the part, and a data sheet regarding the part.

19] An apparatus in accordance with claim 17 wherein said server further configured to download to said device information regarding a part, wherein the information comprises at least one of an electronic model of the part, a drawing of the part, and a data sheet comprising dimensions of the part and tolerances.

20] An apparatus in accordance with claim 17 wherein said server further comprises a database including an electronic model stored therein, said server further configured to regenerate a model upon receipt of the captured change utilizing the stored electronic model.

21] An apparatus in accordance with claim 17 wherein said device comprises a first device and a second device, said server further configured to:
download to said first device information regarding a part; and
download to said second device the regenerated model.

22] An apparatus in accordance with claim 17 wherein said device comprises a first device accessible by a first supplier and a second device accessible by a second supplier, said server further configured to:
download to said first device information regarding a part; and
download to said second device the regenerated model.
